(19) United States
(12) Patent Application Publication
(10) Pub. No.: US 2025/0383526 A1
(43) Pub. Date: Dec. 18, 2025

(54) OPTICAL IMAGING LENS

(71) Applicant: Calin Technology Co., Ltd., Taichung City (TW)

(72) Inventors: FUN-RU LIN, Taichung City (TW); SHU-CHUAN HSU, Taichung City (TW); YUE-JHANG LI, Taichung City (TW)

(73) Assignee: Calin Technology Co., Ltd., Taichung City (TW)

(21) Appl. No.: 18/826,117

(22) Filed: Sep. 5, 2024

(30) Foreign Application Priority Data
Jun. 13, 2024 (TW) 113121830

(51) Int. Cl. G02B 9/06

(52) U.S. Cl. CPC G02B 9/06

(57) ABSTRACT

An optical imaging lens, in order from an object side to an image side along an optical axis, includes a first lens assembly, an aperture, and a second lens assembly. The first lens assembly consists of, in order from the object side to the image side along the optical axis, a first lens having negative refractive power, a second lens having negative refractive power, a third lens having positive refractive power, and a fourth lens having positive refractive power. An image-side surface of the second lens and an object-side surface of the third lens are adhered to form a compound lens. The second lens assembly consists of, in order from the object side to the image side along the optical axis, a fifth lens having negative refractive power, a sixth lens having positive refractive power, and a seventh lens having negative refractive power.

### BACKGROUND OF THE INVENTION

### Technical Field

The present invention generally relates to an optical image capturing system, and more particularly to an optical imaging lens, which provides a better optical performance of low distortion and high image quality.

### Description of Related Art

In recent years, with popularization in portable electronic devices having camera functionalities, the demand for an optical image capturing system is raised gradually. The ordinary optical image capturing system is selected from a charge-coupled device (CCD) or a complementary metal-oxide-semiconductor sensor (CMOS Sensor). Besides, as advanced semiconductor manufacturing technology enables the minimization of the pixel size of the image sensing device, the development of the optical image capturing system towards the field of high pixels. Moreover, with the advancement in drones and driverless autonomous vehicles, Advanced Driver Assistance System (ADAS) plays an important role in the field of vehicle safety, collecting real-time environmental information through various lenses and sensors to provide the comprehensive insights of the driver. Furthermore, as the automotive lens changes with the temperature of an external application environment, the temperature requirements of the image quality of the automotive lens also increase. Therefore, the requirement for high imaging quality is rapidly raised.

Good imaging lenses generally have the advantages of low distortion, high resolution, etc. In practice, small size and cost must be considered. Therefore, it is a big problem for designers to design a lens with good imaging quality under various constraints.

### BRIEF SUMMARY OF THE INVENTION

In view of the reasons mentioned above, the primary objective of the present invention is to provide an optical imaging lens that provides a high image quality.

The present invention provides an optical imaging lens, in order from an object side to an image side along an optical axis, including a first lens assembly, an aperture, and a second lens assembly, wherein the first lens assembly consists of, in order from the object side to the image side along the optical axis, a first lens having negative refractive power, a second lens having negative refractive power, a third lens having positive refractive power, and a fourth lens having positive refractive power. An image-side surface of the second lens and an object-side surface of the third lens are adhered to form a compound lens. The second lens assembly consists of, in order from the object side to the image side along the optical axis, a fifth lens having negative refractive power, a sixth lens having positive refractive power, and a seventh lens having negative refractive power.

The effect of the present invention lies in arranging at least seven lenses into an optical assembly for the optical imaging lens. In addition, the arrangement of the refractive powers and the conditions of the optical imaging lens of the present invention could achieve the effect of high image quality. Moreover, the optical imaging lens includes a compound lens, which could significantly reduce the chromatic aberration of the lens.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1A is a schematic view of the optical imaging lens according to a first embodiment of the present invention;

FIG. 1B is a diagram showing the longitudinal chromatic aberration of the optical imaging lens according to the first embodiment of the present invention;

FIG. 1C is a diagram showing the lateral chromatic aberration of the optical imaging lens according to the first embodiment of the present invention;

FIG. 2A is a schematic view of the optical imaging lens according to a second embodiment of the present invention;

FIG. 2B is a diagram showing the longitudinal chromatic aberration of the optical imaging lens according to the second embodiment of the present invention;

FIG. 2C is a diagram showing the lateral chromatic aberration of the optical imaging lens according to the second embodiment of the present invention;

FIG. 3A is a schematic view of the optical imaging lens according to a third embodiment of the present invention;

FIG. 3B is a diagram showing the longitudinal chromatic aberration of the optical imaging lens according to the third embodiment of the present invention; and

FIG. 3C is a diagram showing the lateral chromatic aberration of the optical imaging lens according to the third embodiment of the present invention.

### DETAILED DESCRIPTION OF THE INVENTION

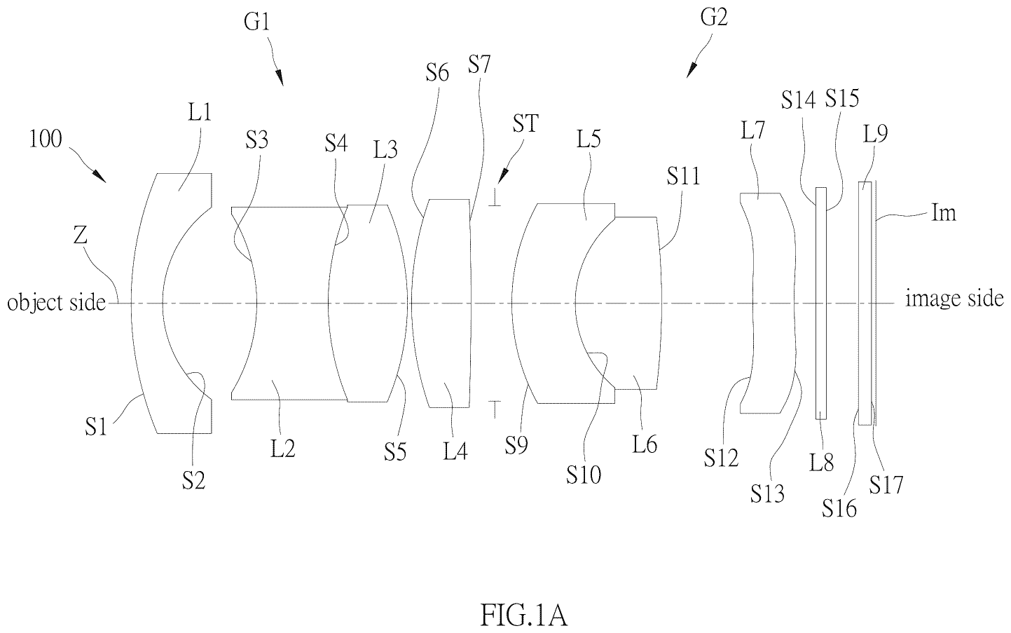

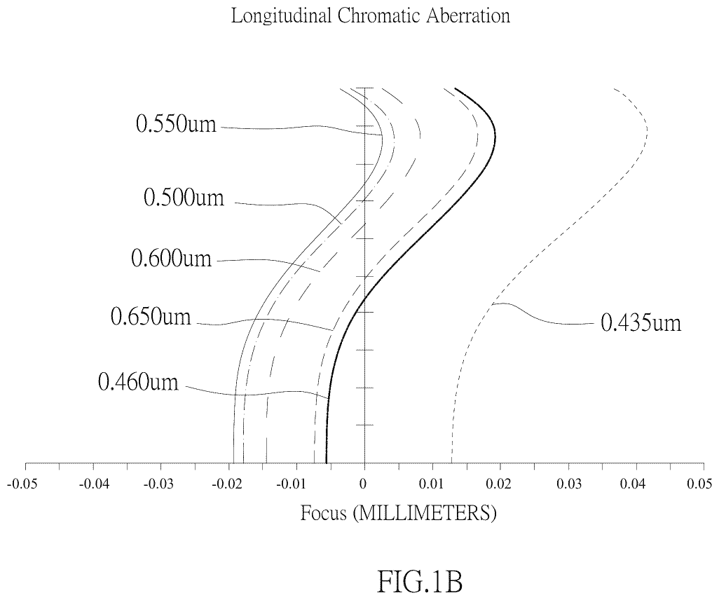

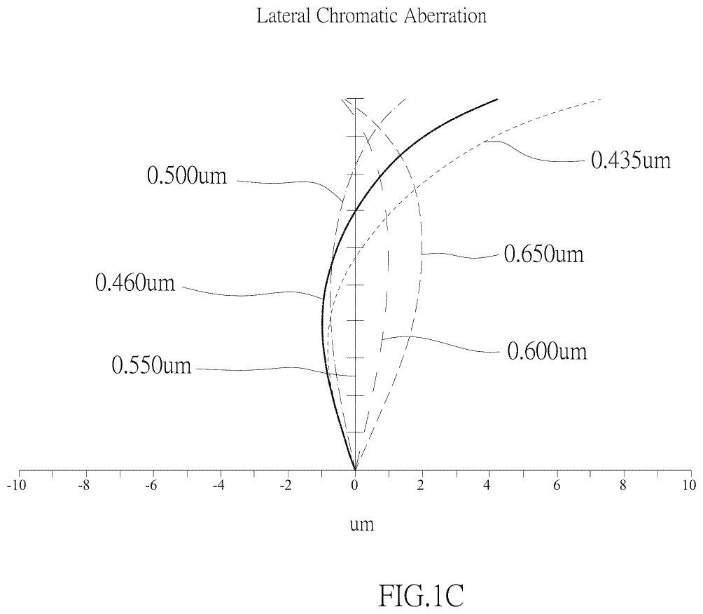

An optical imaging lens 100 according to a first embodiment of the present invention is illustrated in FIG. 1A, which includes, in order along an optical axis Z from an object side to an image side, a first lens assembly G1, an aperture ST, and a second lens assembly G2. In the first embodiment, the optical imaging lens 100 includes at least seven lenses, wherein the first lens assembly G1 consists of, in order along the optical axis Z from the object side to the image side, a first lens L1, a second lens L2, a third lens L3, and a fourth lens L4. The second lens assembly G2 consists of, in order along the optical axis Z from the object side to the image side, a fifth lens L5, a sixth lens L6, and a seventh lens L7.

The first lens L1 has negative refractive power; an object-side surface S1 of the first lens L1 is a convex surface, and an image-side surface S2 of the first lens L1 is a concave surface; both of the object-side surface S1 and the image-side surface S2 of the first lens L1 are aspheric surfaces.

The second lens L2 is a biconcave lens with negative refractive power, wherein both of an object-side surface S3 and an image-side surface S4 of the second lens L2 are spherical surfaces. In the first embodiment, a space is provided between the image-side surface S2 of the first lens L1 and the object-side surface S3 of the second lens L2. In other words, the first lens L1 and the second lens L2 are not adhered to form a compound lens.

The third lens L3 is a biconvex lens with positive refractive power, wherein both of an object-side surface S4 and an image-side surface S5 of the third lens L3 are spherical surfaces. In the first embodiment, the object-side surface S4 of the third lens L3 and the image-side surface S4 of the second lens L2 are correspondingly adhered to form a compound lens having negative refractive power.

The fourth lens L4 is a biconvex lens with positive refractive power, wherein both of an object-side surface S6 and an image-side surface S7 of the fourth lens LA are spherical surfaces. In the first embodiment, a space is provided between the object-side surface S6 of the fourth lens L4 and the image-side surface S5 of the third lens L3. In other words, the third lens L3 and the fourth lens L4 are not adhered to form a compound lens.

The fifth lens L5 has negative refractive power; an object-side surface S9 of the fifth lens L5 is a convex surface, and an image-side surface S10 of the fifth lens L5 is a concave surface; both of the object-side surface S9 and the image-side surface S10 of the fifth lens L5 are spherical surfaces.

The sixth lens L6 is a biconvex lens with positive refractive power, wherein both of an object-side surface S10 and an image-side surface S11 of the sixth lens L6 are spherical surfaces. In the first embodiment, the object-side surface S10 of the sixth lens L6 and the image-side surface S10 of the fifth lens L5 are correspondingly adhered to form a compound lens having positive refractive power.

The seventh lens L7 has negative refractive power. An object-side surface S12 of the seventh lens L7 is convex at a point where the optical axis Z passes through, and an image-side surface S13 of the seventh lens L7 is concave at a point where the optical axis Z passes through. Both of the object-side surface S12 and the image-side surface S13 of the seventh lens L7 are aspheric surfaces. Additionally, the object-side surface S12 of the seventh lens L7 has an inflection point, so that the object-side surface S12 of the seventh lens L7 gradually changes from convex to concave as the object-side surface S12 extends outward from the point where the optical axis Z passes through. Similarly, the image-side surface S13 of the seventh lens L7 has an inflection point, so that the image-side surface S13 of the seventh lens L7 gradually changes from concave to convex as the image-side surface S13 extends outward from the point where the optical axis Z passes through. In the first embodiment, a space is provided between the object-side surface S12 of the seventh lens L7 and the image-side surface S11 of the sixth lens L6. In other words, the sixth lens L6 and the seventh lens L7 are not adhered to form a compound lens.

Additionally, the optical imaging lens 100 further includes an infrared filter L8 and a protective glass L9, wherein the infrared filter L8 forms an object-side surface S14 facing the object side and an image-side surface S15 facing the image side. The infrared filter L8 is disposed on one side of the image-side surface S13 of the seventh lens L7, thereby restricting infrared rays passing through the optical imaging lens 100 to improve the quality and fidelity of the image. The protective glass L9 forms an object-side surface S16 facing the object side and an image-side surface S17 facing the image side. The protective glass L9 is disposed on one side of the infrared filter L8 and is located between the infrared filter L8 and an image plane Im to protect the infrared filter L8.

In order to keep the optical imaging lens 100 in good optical performance and high imaging quality, the optical imaging lens 100 satisfies:

$$- 0.49 < F / f 1 < - 0.46 ; \qquad ( 1 )$$

$$- 1.27 < F / f 2 < - 1.23 ; \qquad ( 2 )$$

$$0.91 < F / f 3 < 0.94 ; \qquad ( 3 )$$

$$- 0.02 < F / f 23 < - 0.007 ; \qquad ( 4 )$$

$$0.44 < F / f 4 < 0.46 ; \qquad ( 5 )$$

$$- 0.6 < F / f 5 < - 0.4 ; \qquad ( 6 )$$

$$0.84 < F / f 6 < 0.88 ; \qquad ( 7 )$$

$$0.25 < F / f 56 < 0.29 ; \qquad ( 8 )$$

$$- 0.04 < F / f 7 < - 0.02 ; \qquad ( 9 )$$

$$24. < fg 2 < 28. ; \qquad ( 10 )$$

$$0.4 < F / fg 1 < 0.6 ; \qquad ( 11 )$$

$$0.25 < F / fg 2 < 0.27 ; \qquad ( 12 )$$

$$2.4 < F / ( f 1 + f 2 + f 3 + f 4 ) < 3. . \qquad ( 13 )$$

wherein Fis a focal length of the optical imaging lens 100; f1 is a focal length of the first lens L1; f2 is a focal length of the second lens L2; f3 is a focal length of the third lens L3; f23 is a focal length (cemented focal length) of the compound lens formed by adhering the second lens L2 and the third lens L3; f4 is a focal length of the fourth lens L4; f5 is a focal length of the fifth lens L5; f6 is a focal length of the sixth lens L6; f56 is a focal length (cemented focal length) of the compound lens formed by adhering the fifth lens L5 and the sixth lens L6; f7 is a focal length of the seventh lens L7; fg1 is a focal length of the first lens assembly G1; fg2 is a focal length of the second lens assembly G2.

Parameters of the optical imaging lens 100 of the first embodiment of the present invention are listed in following Table 1, including the focal length F of the optical imaging lens 100 (also called an effective focal length (EFL)), a F-number (Fno), a maximal field of view (FOV), a radius of curvature (R) of each lens, a distance (D) between each surface and the next surface on the optical axis Z, a refractive index (Nd) of each lens, an Abbe number (Vd) of each lens, the focal length of each lens, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 1
F = 6.81 mm; Fno = 1.67; FOV = 80.9 deg

| | | | | | | Cemented | | |
|---|---|---|---|---|---|---|---|---|
| | | | | | Focal | focal | Focal | |
| Surface | R(mm) | D(mm) | Nd | Vd | length | length | length | Note |
| S1 | 13.135 | 1.201 | 1.583 | 59.382 | −14.087 | | 14.047 | First lens |
| | | | | | | | | L1 |
| S2 | 4.894 | 3.563 | | | | | | |
| S3 | −6.893 | 2.749 | 1.702 | 41.132 | −5.381 | −622.622 | | Second |
| | | | | | | | | lens L2 |
| S4 | 9.835 | 3.019 | 1.720 | 50.332 | 7.268 | | | Third |
| | | | | | | | | lens L3 |
| S5 | −9.832 | 0.140 | | | | | | |
| S6 | 12.112 | 2.268 | 1.744 | 44.893 | 14.926 | | | Fourth |
| | | | | | | | | lens L4 |
| S7 | −130.281 | 0.902 | | | | | | |
| ST | INFINITY | 0.654 | | | | | | Aperture |
| | | | | | | | | ST |
| S9 | 8.090 | 2.413 | 1.923 | 18.896 | −14.037 | 24.221 | 25.493 | Fifth |
| | | | | | | | | lens L5 |
| S10 | 4.281 | 3.268 | 1.497 | 81.556 | 7.782 | | | Sixth |
| | | | | | | | | lens L6 |
| S11 | −30.704 | 3.478 | | | | | | |
| S12 | 24.93 | 1.581 | 1.516 | 64.067 | −203.944 | | | Seventh |
| | | | | | | | | lens L7 |
| S13 | 19.734 | 0.821 | | | | | | |
| S14 | INFINITY | 0.400 | 1.517 | 64.167 | | | | Infrared |
| | | | | | | | | Filter L8 |
| S15 | INFINITY | 1.217 | | | | | | |
| S16 | INFINITY | 0.500 | 1.517 | 64.167 | | | | Protective |
| | | | | | | | | Glass L9 |
| S17 | INFINITY | 0.163 | | | | | | |
| Im | INFINITY | 0.000 | | | | | | Image |
| | | | | | | | | Plane Im |

It could be seen from Table 1 that, in the first embodiment, the focal length F of the optical imaging lens 100 is 6.81 mm, and the Fno is 1.67, and the FOV is 80.9 degrees, wherein the focal length f1 of the first lens L1 is −14.087 mm; the focal length f2 of the second lens L2 is −5.381 mm; the focal length f3 of the third lens L3 is 7.268 mm; the focal length f4 of the fourth lens L4 is 14.926 mm; the focal length f5 of the fifth lens L5 is −14.037 mm; the focal length f6 of the sixth lens L6 is 7.782 mm; the focal length f7 of the seventh lens L7 is −203.944 mm; the focal length f23 (cemented focal length) of the compound lens formed by adhering the second lens L2 and the third lens L3 is −622.622 mm; the focal length f56 (cemented focal length) of the compound lens formed by adhering the fifth lens L5 and the sixth lens L6 is 24.221 mm; the focal length fg1 of the first lens assembly G1 is 14.047 mm; the focal length fg2 of the second lens assembly G2 is 25.493 mm.

Additionally, based on the above detailed parameters, detailed values of the aforementioned conditions (1) to (13) in the first embodiment are as follows:

$$F / f 1 = - 0.483 ; \qquad ( 1 )$$

$$F / f 2 = - 1.265 ; \qquad ( 2 )$$

$$F / f 3 = 0.936 ; \qquad ( 3 )$$

$$F / f 23 = - 0.011 ; \qquad ( 4 )$$

$$F / f 4 = 0.456 ; \qquad ( 5 )$$

$$F / f 5 = - 0.485 ; \qquad ( 6 )$$

$$F / f 6 = 0.875 ; \qquad ( 7 )$$

$$F / f 56 = 0.281 ; \qquad ( 8 )$$

$$F / f 7 = - 0.033 ; \qquad ( 9 )$$

$$fg 2 = 25.493 ; \qquad ( 10 )$$

$$F / fg 1 = 0.485 ; \qquad ( 11 )$$

$$F / fg 2 = 0.267 ; \qquad ( 12 )$$

$$F / ( f 1 + f 2 + f 3 + f 4 ) = 2.497 . \qquad ( 13 )$$

With the parameters from Table 1, in the first embodiment, the focal length of each lens, the focal length (cemented focal length) of each compound lens, the focal length fg1 of the first lens assembly G1, and the focal length fg2 of the second lens assembly G2 satisfy the aforementioned conditions (1) to (13) of the optical imaging lens 100.

Additionally, the optical imaging lens 100 further satisfies:

$$0.514 < f / R 1 < 0.519 ; \qquad ( 14 )$$

$$1.354 < f / R 2 < 1.4 ; \qquad ( 15 )$$

$$- 0.993 < f / R 3 < - 0.961 ; \qquad ( 16 )$$

$$0.673 < f / R 4 < 0.698 ; \qquad ( 17 )$$

$$- 0.699 < f / R 5 < - 0.674 ; \qquad ( 18 )$$

$$0.552 < f / R 6 < 0.565 ; \qquad ( 19 )$$

$$- 0.054 < f / R 7 < - 0.05 ; \qquad ( 20 )$$

$$0.82 < f / R 9 < 0.842 ; \qquad ( 21 )$$

$$1.529 < f / R 10 < 1.595 ; \qquad ( 22 )$$

$$- 0.223 < f / R 11 < - 0.207 ; \qquad ( 23 )$$

$$0.265 < f / R 12 < 0.276 ; \qquad ( 24 )$$

$$0.3 < F / R 13 < 0.4 . \qquad ( 25 )$$

wherein F is the focal length of the optical imaging lens 100; R1 is a radius of curvature of the object-side surface S1 of the first lens L1; R2 is a radius of curvature of the image-side surface S2 of the first lens L1; R3 is a radius of curvature of the object-side surface S3 of the second lens L2; R4 is a radius of curvature of a surface formed by correspondingly adhering the image-side surface S4 of the second lens L2 and the object-side surface S4 of the third lens L3; R5 is a radius of curvature of the image-side surface S5 of the third lens L3; R6 is a radius of curvature of the object-side surface S6 of the fourth lens L4; R7 is a radius of curvature of the image-side surface S7 of the fourth lens L4; R9 is a radius of curvature of the object-side surface S9 of the fifth lens L5; R10 is a radius of curvature of a surface formed by correspondingly adhering the image-side surface S10 of the fifth lens L5 and the object-side surface S10 of the sixth lens L6; R11 is a radius of curvature of the image-side surface S11 of the sixth lens L6; R12 is a radius of curvature of the object-side surface S12 of the seventh lens L7; R13 is a radius of curvature of the image- side surface S13 of the seventh lens L7.

Based on the detailed parameters of Table 1, detailed values of the aforementioned conditions (14) to (25) in the first embodiment are as follows:

$$f / R 1 = 0.518 ; \qquad ( 14 )$$

$$f / R 2 = 1.391 ; \qquad ( 15 )$$

$$f / R 3 = - 0.987 ; \qquad ( 16 )$$

$$f / R 4 = 0.692 ; \qquad ( 17 )$$

$$f / R 5 = - 0.692 ; \qquad ( 18 )$$

$$f / R 6 = 0.562 ; \qquad ( 19 )$$

$$f / R 7 = - 0.052 ; \qquad ( 20 )$$

$$f / R 9 = 0.841 ; \qquad ( 21 )$$

$$f / R 10 = 1.59 ; \qquad ( 22 )$$

$$f / R 11 = - 0.222 ; \qquad ( 23 )$$

$$f / R 12 = 0.273 ; \qquad ( 24 )$$

$$f / R 13 = 0.345 . \qquad ( 25 )$$

With the parameters from Table 1, each of the related values in the first embodiment satisfies the aforementioned conditions (14) to (25) of the optical imaging lens 100.

Moreover, an aspheric surface contour shape Z of each of the object-side surface S1 of the first lens L1, the image-side surface S2 of the first lens L1, the object-side surface S12 of the seventh lens L7, and the image-side surface S13 of the seventh lens L7 according to the first embodiment could be obtained by following formula:

$$Z = \frac{{ch}^{2}}{1 + \sqrt{1 - ( 1 + k ) {c}^{2} {h}^{2}}} + {A}_{2} {h}^{2} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A2, A4, A6, A8, A10, A12, A14 and A16 respectively represents different order coefficient of h.

In the optical imaging lens 100 according to the first embodiment, the conic constant k of each of the aspheric surfaces and the different order coefficient of A2, A4, A6, A8, A10, A12, A14, and A16 are listed in following Table 2:

TABLE 2

| Sur- | | | | |
|---|---|---|---|---|
| face | S1 | S2 | S12 | S13 |
| k | −18.33 | −0.1319 | 28.7669 | 0 |
| A2 | 0 | 0 | 0 | 0 |
| A4 | 1.6560E−03 | 1.1964E−03 | −3.9019E−03 | −3.4008E−03 |
| A6 | −7.8211E−05 | 4.3416E−05 | −1.7468E−05 | 2.0201E−05 |
| A8 | 1.6734E−06 | −1.3711E−05 | −1.3748E−06 | −8.8902E−06 |
| A10 | 3.9644E−09 | 1.3244E−06 | 9.4078E−08 | 1.0378E−06 |
| A12 | −1.0572E−09 | −5.5287E−08 | 7.1939E−09 | −4.7186E−08 |
| A14 | 1.5295E−11 | 1.0005E−09 | 0 | 9.1205E−10 |
| A16 | 0 | 0 | 0 | 0 |

Taking optical simulation data to verify the imaging quality of the optical imaging lens 100, wherein FIG. 1B is a diagram showing the longitudinal chromatic aberration according to the first embodiment. From FIG. 1B, it could be observed that the curves formed by each wavelength are close to one another, thereby significantly enhancing chromatic aberration. The skewness of each curve shows that the deviation of the imaging points of off-axis rays is controlled within the range of ±0.04 millimeters. Therefore, in the first embodiment, chromatic aberration for different wavelengths is significantly improved.

The lateral chromatic aberration according to the first embodiment is illustrated in FIG. 1C. From FIG. 1C, it could be observed that the lateral chromatic aberration of both the shortest wavelength and the longest wavelength irradiating on the image plane is less than 8 micrometers, indicating that the optical imaging lens 100 has low lateral chromatic aberration. The rays of different wavelengths tend to converge at the image plane, thereby improving color accuracy and image quality.

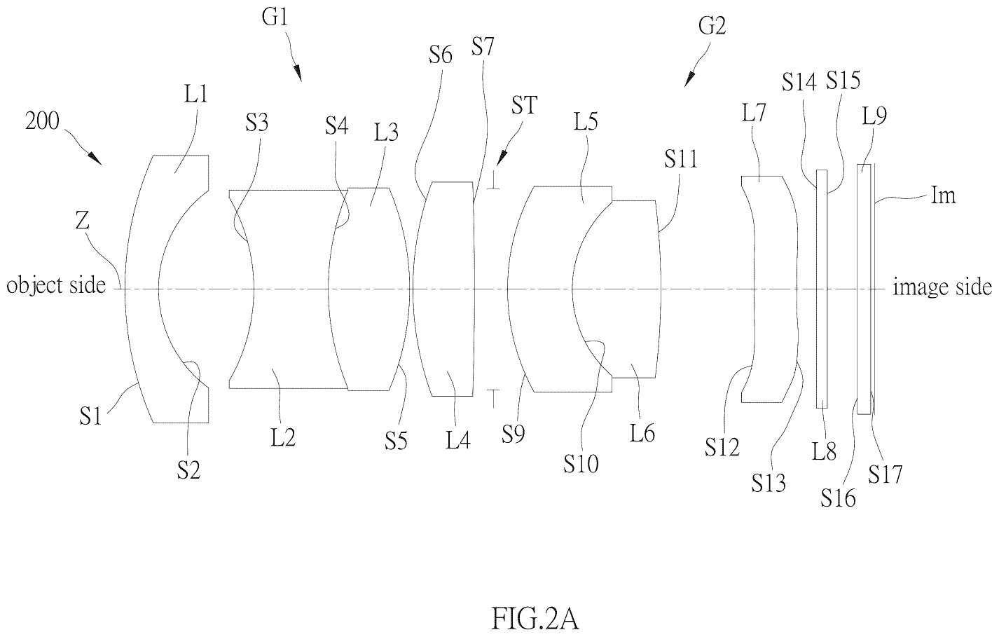

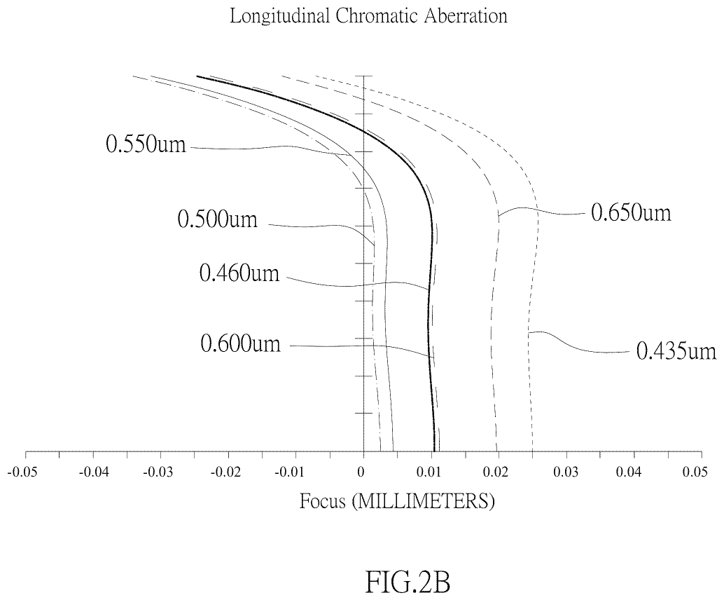

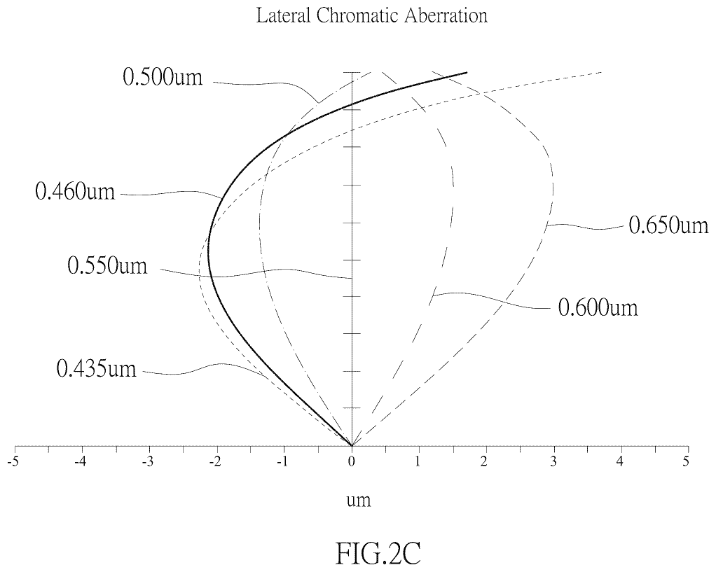

An optical imaging lens 200 according to a second embodiment of the present invention is illustrated in FIG. 2A, which includes, in order along an optical axis Z from an object side to an image side, a first lens assembly G1, an aperture ST, and a second lens assembly G2. In the second embodiment, the optical imaging lens 200 includes at least seven lenses, wherein the first lens assembly G1 consists of, in order along the optical axis Z from the object side to the image side, a first lens L1, a second lens L2, a third lens L3, and a fourth lens L4. The second lens assembly G2 consists of, in order along the optical axis Z from the object side to the image side, a fifth lens L5, a sixth lens L6, and a seventh lens L7.

The first lens L1 has negative refractive power; an object-side surface S1 of the first lens L1 is a convex surface, and an image-side surface S2 of the first lens L1 is a concave surface; both of the object-side surface S1 and the image-side surface S2 of the first lens L1 are aspheric surfaces.

The second lens L2 is a biconcave lens with negative refractive power, wherein both of an object-side surface S3 and an image-side surface S4 of the second lens L2 are spherical surfaces. In the second embodiment, a space is provided between the image-side surface S2 of the first lens L1 and the object-side surface S3 of the second lens L2. In other words, the first lens L1 and the second lens L2 are not adhered to form a compound lens.

The third lens L3 is a biconvex lens with positive refractive power, wherein both of an object-side surface S4 and an image-side surface S5 of the third lens L3 are spherical surfaces. In the second embodiment, the object-side surface S4 of the third lens L3 and the image-side surface S4 of the second lens L2 are correspondingly adhered to form a compound lens having negative refractive power.

The fourth lens L4 is a biconvex lens with positive refractive power, wherein both of an object-side surface S6 and an image-side surface S7 of the fourth lens L4 are spherical surfaces. In the second embodiment, a space is provided between the object-side surface S6 of the fourth lens L4 and the image-side surface S5 of the third lens L3. In other words, the third lens L3 and the fourth lens LA are not adhered to form a compound lens.

The fifth lens L5 has negative refractive power; an object-side surface S9 of the fifth lens L5 is a convex surface, and an image-side surface S10 of the fifth lens L5 is a concave surface; both of the object-side surface S9 and the image-side surface S10 of the fifth lens L5 are spherical surfaces.

The sixth lens L6 is a biconvex lens with positive refractive power, wherein both of an object-side surface S10 and an image-side surface S11 of the sixth lens L6 are spherical surfaces. In the second embodiment, the object-side surface S10 of the sixth lens L6 and the image-side surface S10 of the fifth lens L5 are correspondingly adhered to form a compound lens having positive refractive power.

The seventh lens L7 has negative refractive power. An object-side surface S12 of the seventh lens L7 is convex at a point where the optical axis Z passes through, and an image-side surface S13 of the seventh lens L7 is concave at a point where the optical axis Z passes through. Both of the object-side surface S12 and the image-side surface S13 of the seventh lens L7 are aspheric surfaces. Additionally, the object-side surface S12 of the seventh lens L7 has an inflection point, so that the object-side surface S12 of the seventh lens L7 gradually changes from convex to concave as the object-side surface S12 extends outward from the point where the optical axis Z passes through. Similarly, the image-side surface S13 of the seventh lens L7 has an inflection point, so that the image-side surface S13 of the seventh lens L7 gradually changes from concave to convex as the image-side surface S13 extends outward from the point where the optical axis Z passes through. In the second embodiment, a space is provided between the object-side surface S12 of the seventh lens L7 and the image-side surface S11 of the sixth lens L6. In other words, the sixth lens L6 and the seventh lens L7 are not adhered to form a compound lens.

Additionally, the optical imaging lens 200 further includes an infrared filter L8 and a protective glass L9, wherein the infrared filter L8 forms an object-side surface S14 facing the object side and an image-side surface S15 facing the image side. The infrared filter L8 is disposed on one side of the image-side surface S13 of the seventh lens L7, thereby restricting infrared rays passing through the optical imaging lens 200 to improve the quality and fidelity of the image. The protective glass L9 forms an object-side surface S16 facing the object side and an image-side surface S17 facing the image side. The protective glass L9 is disposed on one side of the infrared filter L8 and is located between the infrared filter L8 and an image plane Im to protect the infrared filter L8.

In order to keep the optical imaging lens 200 in good optical performance and high imaging quality, the optical imaging lens 200 satisfies:

$$- 0.49 < F / f 1 < - 0.46 ; \qquad ( 1 )$$

$$- 1.27 < F / f 2 < - 1.23 ; \qquad ( 2 )$$

$$0.91 < F / f 3 < 0.94 ; \qquad ( 3 )$$

$$- 0.02 < F / f 23 < - 0.007 ; \qquad ( 4 )$$

$$0.44 < F / f 4 < 0.46 ; \qquad ( 5 )$$

$$- 0.6 < F / f 5 < - 0.4 ; \qquad ( 6 )$$

$$0.84 < F / f 6 < 0.88 ; \qquad ( 7 )$$

$$0.25 < F / f 56 < 0.29 ; \qquad ( 8 )$$

$$- 0.04 < F / f 7 < - 0.02 ; \qquad ( 9 )$$

$$24. < fg 2 < 28. ; \qquad ( 10 )$$

$$0.4 < F / fg 1 < 0.6 ; \qquad ( 11 )$$

$$0.25 < F / fg 2 < 0.27 ; \qquad ( 12 )$$

$$2.4 < F / ( f 1 + f 2 + f 3 + f 4 ) < 3. . \qquad ( 13 )$$

wherein F is a focal length of the optical imaging lens 200; f1 is a focal length of the first lens L1; f2 is a focal length of the second lens L2; f3 is a focal length of the third lens L3; f23 is a focal length (cemented focal length) of the compound lens formed by adhering the second lens L2 and the third lens L3; f4 is a focal length of the fourth lens L4; f5 is a focal length of the fifth lens L5; f6 is a focal length of the sixth lens L6; f56 is a focal length (cemented focal length) of the compound lens formed by adhering the fifth lens L5 and the sixth lens L6; f7 is a focal length of the seventh lens L7; fg1 is a focal length of the first lens assembly G1; fg2 is a focal length of the second lens assembly G2.

Parameters of the optical imaging lens 200 of the second embodiment of the present invention are listed in following Table 3, including the focal length F of the optical imaging lens 200 (also called an effective focal length (EFL)), a F-number (Fno), a maximal field of view (FOV), a radius of curvature (R) of each lens, a distance (D) between each surface and the next surface on the optical axis Z, a refractive index (Nd) of each lens, an Abbe number (Vd) of each lens, the focal length of each lens, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 3
F = 6.63 mm; Fno = 1.62; FOV = 83.8 deg

| | | | | | | Cemented | | |
|---|---|---|---|---|---|---|---|---|
| | | | | | Focal | focal | Focal | |
| Surface | R(mm) | D(mm) | Nd | Vd | length | length | length | Note |
| S1 | 12.865 | 1.200 | 1.583 | 59.382 | −14.286 | | 13.777 | First lens |
| | | | | | | | | L1 |
| S2 | 4.893 | 3.563 | | | | | | |
| S3 | −6.893 | 2.749 | 1.702 | 41.132 | −5.382 | −626.460 | | Second |
| | | | | | | | | lens L2 |
| S4 | 9.836 | 3.019 | 1.720 | 50.332 | 7.268 | | | Third |
| | | | | | | | | lens L3 |
| S5 | −9.831 | 0.135 | | | | | | |
| S6 | 11.981 | 2.268 | 1.744 | 44.893 | 14.777 | | | Fourth |
| | | | | | | | | lens L4 |
| S7 | −130.158 | 0.700 | | | | | | |
| ST | INFINITY | 0.528 | | | | | | Aperture |
| | | | | | | | | ST |
| S9 | 8.077 | 2.400 | 1.923 | 18.896 | −14.507 | 23.568 | 24.733 | Fifth |
| | | | | | | | | lens L5 |
| S10 | 4.333 | 3.265 | 1.497 | 81.556 | 7.864 | | | Sixth |
| | | | | | | | | lens L6 |
| S11 | −30.702 | 3.478 | | | | | | |
| S12 | 24.929 | 1.581 | 1.516 | 64.067 | −204.142 | | | Seventh |
| | | | | | | | | lens L7 |
| S13 | 19.737 | 0.740 | | | | | | |
| S14 | INFINITY | 0.400 | 1.517 | 64.167 | | | | Infrared |
| | | | | | | | | Filter L8 |
| S15 | INFINITY | 1.112 | | | | | | |
| S16 | INFINITY | 0.500 | 1.517 | 64.167 | | | | Protective |
| | | | | | | | | Glass L9 |
| S17 | INFINITY | 0.150 | | | | | | |
| Im | INFINITY | 0.000 | | | | | | Image |
| | | | | | | | | Plane Im |

It could be seen from Table 3 that, in the second embodiment, the focal length F of the optical imaging lens 200 is 6.63 mm, and the Fno is 1.62, and the FOV is 83.8 degrees, wherein the focal length f1 of the first lens L1 is −14.286 mm; the focal length f2 of the second lens L2 is −5.382 mm; the focal length f3 of the third lens L3 is 7.268 mm; the focal length f4 of the fourth lens L4 is 14.777 mm; the focal length f5 of the fifth lens L5 is −14.507 mm; the focal length f6 of the sixth lens L6 is 7.864 mm; the focal length f7 of the seventh lens L7 is −204.142 mm; the focal length f23 (cemented focal length) of the compound lens formed by adhering the second lens L2 and the third lens L3 is −626.460 mm; the focal length f56 (cemented focal length) of the compound lens formed by adhering the fifth lens L5 and the sixth lens L6 is 23.568 mm; the focal length fg1 of the first lens assembly G1 is 13.777 mm; the focal length fg2 of the second lens assembly G2 is 24.733 mm.

Additionally, based on the above detailed parameters, detailed values of the aforementioned conditions (1) to (13) in the second embodiment are as follows:

$$F / f 1 = - 0.464 ; \qquad ( 1 )$$

$$F / f 2 = - 1.232 ; \qquad ( 2 )$$

$$F / f 3 = 0.912 ; \qquad ( 3 )$$

$$F / f 23 = - 0.011 ; \qquad ( 4 )$$

$$F / f 4 = 0.449 ; \qquad ( 5 )$$

$$F / f 5 = - 0.457 ; \qquad ( 6 )$$

$$F / f 6 = 0.843 ; \qquad ( 7 )$$

$$F / f 56 = 0.281 ; \qquad ( 8 )$$

$$F / f 7 = - 0.032 ; \qquad ( 9 )$$

$$fg 2 = 24.733 ; \qquad ( 10 )$$

$$F / fg 1 = 0.481 ; \qquad ( 11 )$$

$$F / fg 2 = 0.268 ; \qquad ( 12 )$$

$$F / ( f 1 + f 2 + f 3 + f 4 ) = 2.789 . \qquad ( 13 )$$

With the parameters from Table 3, in the second embodiment, the focal length of each lens, the focal length (cemented focal length) of each compound lens, the focal length fg1 of the first lens assembly G1, and the focal length fg2 of the second lens assembly G2 satisfy the aforementioned conditions (1) to (13) of the optical imaging lens 200.

Additionally, the optical imaging lens 200 further satisfies:

$$0.514 < f / R 1 < 0.519 ; \qquad ( 14 )$$

$$1.354 < f / R 2 < 1.4 ; \qquad ( 15 )$$

$$- 0.993 < f / R 3 < - 0.961 ; \qquad ( 16 )$$

$$0.673 < f / R 4 < 0.698 ; \qquad ( 17 )$$

$$- 0.699 < f / R 5 < - 0.674 ; \qquad ( 18 )$$

$$0.552 < f / R 6 < 0.565 ; \qquad ( 19 )$$

$$- 0.054 < f / R 7 < - 0.05 ; \qquad ( 20 )$$

$$0.82 < f / R 9 < 0.842 ; \qquad ( 21 )$$

$$1.529 < f / R 10 < 1.595 ; \qquad ( 22 )$$

$$- 0.223 < f / R 11 < - 0.207 ; \qquad ( 23 )$$

$$0.265 < f / R 12 < 0.276 ; \qquad ( 24 )$$

$$0.3 < F / R 13 < 0.4 . \qquad ( 25 )$$

wherein F is the focal length of the optical imaging lens 200; R1 is a radius of curvature of the object-side surface S1 of the first lens L1; R2 is a radius of curvature of the image-side surface S2 of the first lens L1; R3 is a radius of curvature of the object-side surface S3 of the second lens L2; R4 is a radius of curvature of a surface formed by correspondingly adhering the image-side surface S4 of the second lens L2 and the object-side surface S4 of the third lens L3; R5 is a radius of curvature of the image-side surface S5 of the third lens L3; R6 is a radius of curvature of the object-side surface S6 of the fourth lens L4; R7 is a radius of curvature of the image-side surface S7 of the fourth lens L4; R9 is a radius of curvature of the object-side surface S9 of the fifth lens L5; R10 is a radius of curvature of a surface formed by correspondingly adhering the image-side surface S10 of the fifth lens L5 and the object-side surface S10 of the sixth lens L6; R11 is a radius of curvature of the image-side surface S11 of the sixth lens L6; R12 is a radius of curvature of the object-side surface S12 of the seventh lens L7; R13 is a radius of curvature of the image- side surface S13 of the seventh lens L7.

Based on the detailed parameters of Table 3, detailed values of the aforementioned conditions (14) to (25) in the second embodiment are as follows:

$$f / R 1 = 0.515 ; \qquad ( 14 )$$

$$f / R 2 = 1.355 ; \qquad ( 15 )$$

$$f / R 3 = - 0.962 ; \qquad ( 16 )$$

$$f / R 4 = 0.674 ; \qquad ( 17 )$$

$$f / R 5 = - 0.675 ; \qquad ( 18 )$$

$$f / R 6 = 0.553 ; \qquad ( 19 )$$

$$f / R 7 = - 0.051 ; \qquad ( 20 )$$

$$f / R 9 = 0.821 ; \qquad ( 21 )$$

$$f / R 10 = 1.53 ; \qquad ( 22 )$$

$$f / R 11 = - 0.216 ; \qquad ( 23 )$$

$$f / R 12 = 0.266 ; \qquad ( 24 )$$

$$f / R 13 = 0.336 . \qquad ( 25 )$$

With the parameters from Table 3, each of the related values in the second embodiment satisfies the aforementioned conditions (14) to (25) of the optical imaging lens 200.

Moreover, an aspheric surface contour shape Z of each of the object-side surface S1 of the first lens L1, the image-side surface S2 of the first lens L1, the object-side surface S12 of the seventh lens L7, and the image-side surface S13 of the seventh lens L7 according to the second embodiment could be obtained by following formula:

$$Z = \frac{{ch}^{2}}{1 + \sqrt{1 - ( 1 + k ) {c}^{2} {h}^{2}}} + {A}_{2} {h}^{2} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A2, A4, A6, A8, A10, A12, A14 and A16 respectively represents different order coefficient of h.

In the optical imaging lens 200 according to the second embodiment, the conic constant k of each of the aspheric surfaces and the different order coefficient of A2, A4, A6, A8, A10, A12, A14, and A16 are listed in following Table 4:

TABLE 4

| Sur- | | | | |
|---|---|---|---|---|
| face | S1 | S2 | S12 | S13 |
| k | −18.33 | −0.1319 | 28.7669 | 0 |
| A2 | 0 | 0 | 0 | 0 |
| A4 | 1.6560E−03 | 1.1964E−03 | −3.9019E−03 | −3.4008E−03 |
| A6 | −7.8211E−05 | 4.3416E−05 | −1.7468E−05 | 2.0201E−05 |
| A8 | 1.6734E−06 | −1.3711E−05 | −1.3748E−06 | −8.8902E−06 |
| A10 | 3.9644E−09 | 1.3244E−06 | 9.4078E−08 | 1.0378E−06 |
| A12 | −1.0572E−09 | −5.5287E−08 | 7.1939E−09 | −4.7186E−08 |
| A14 | 1.5295E−11 | 1.0005E−09 | 0 | 9.1205E−10 |
| A16 | 0 | 0 | 0 | 0 |

Taking optical simulation data to verify the imaging quality of the optical imaging lens 200, wherein FIG. 2B is a diagram showing the longitudinal chromatic aberration according to the second embodiment. From FIG. 2B, it could be observed that the curves formed by each wavelength are close to one another, thereby significantly enhancing chromatic aberration. The skewness of each curve shows that the deviation of the imaging points of off-axis rays is controlled within the range of ±0.04 millimeters. Therefore, in the second embodiment, chromatic aberration for different wavelengths is significantly improved.

The lateral chromatic aberration according to the second embodiment is illustrated in FIG. 2C. From FIG. 2C, it could be observed that the lateral chromatic aberration of both the shortest wavelength and the longest wavelength irradiating on the image plane is less than 4 micrometers, indicating that the optical imaging lens 200 has low lateral chromatic aberration. The rays of different wavelengths tend to converge at the image plane, thereby improving color accuracy and image quality.

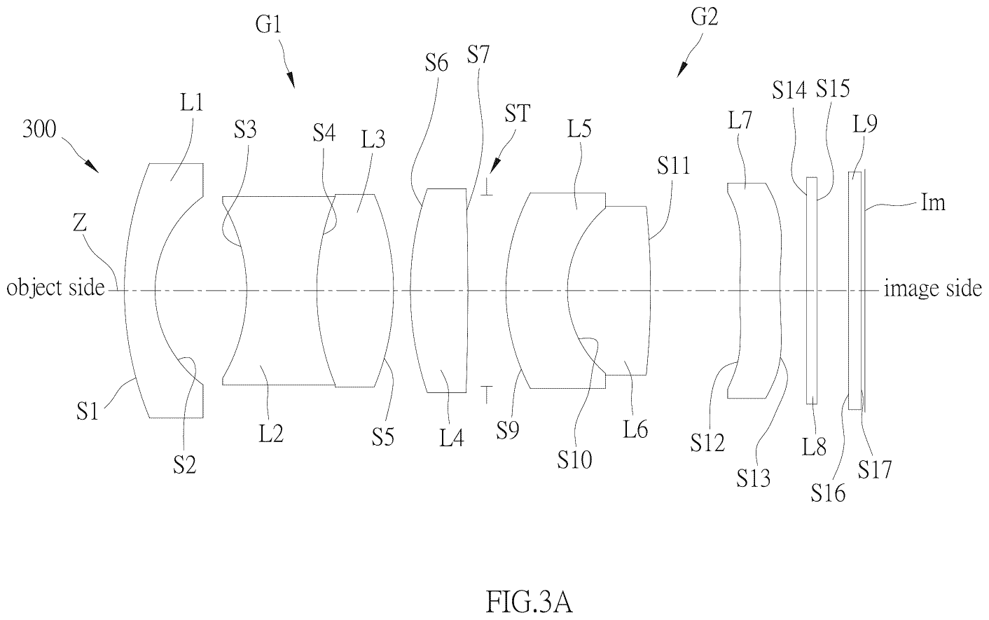

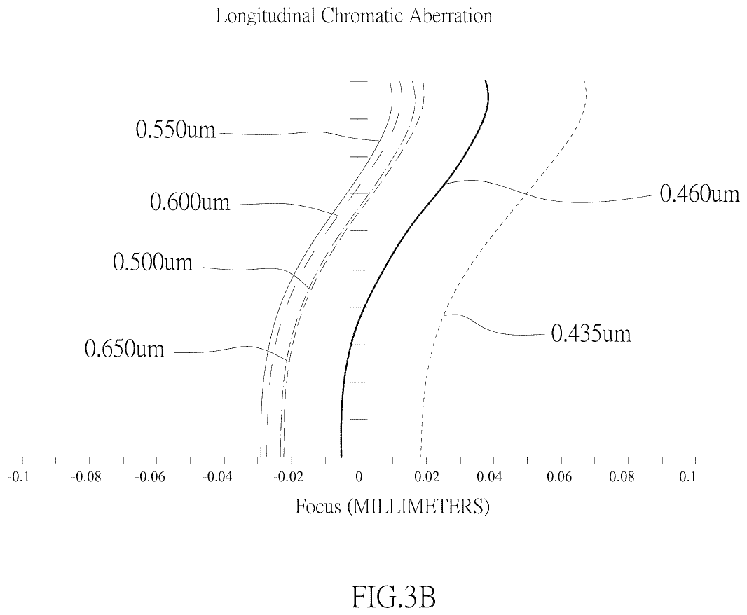

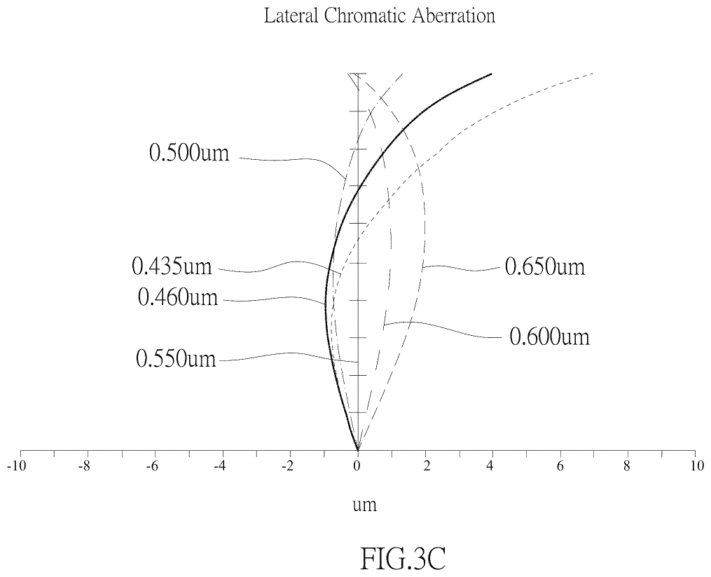

An optical imaging lens 300 according to a third embodiment of the present invention is illustrated in FIG. 3A, which includes, in order along an optical axis Z from an object side to an image side, a first lens assembly G1, an aperture ST, and a second lens assembly G2. In the third embodiment, the optical imaging lens 300 includes at least seven lenses, wherein the first lens assembly G1 consists of, in order along the optical axis Z from the object side to the image side, a first lens L1, a second lens L2, a third lens L3, and a fourth lens L4. The second lens assembly G2 consists of, in order along the optical axis Z from the object side to the image side, a fifth lens L5, a sixth lens L6, and a seventh lens L7.

The first lens L1 has negative refractive power; an object-side surface S1 of the first lens L1 is a convex surface, and an image-side surface S2 of the first lens L1 is a concave surface; both of the object-side surface S1 and the image-side surface S2 of the first lens L1 are aspheric surfaces.

The second lens L2 is a biconcave lens with negative refractive power, wherein both of an object-side surface S3 and an image-side surface S4 of the second lens L2 are spherical surfaces. In the third embodiment, a space is provided between the image-side surface S2 of the first lens L1 and the object-side surface S3 of the second lens L2. In other words, the first lens L1 and the second lens L2 are not adhered to form a compound lens.

The third lens L3 is a biconvex lens with positive refractive power, wherein both of an object-side surface S4 and an image-side surface S5 of the third lens L3 are spherical surfaces. In the third embodiment, the object-side surface S4 of the third lens L3 and the image-side surface S4 of the second lens L2 are correspondingly adhered to form a compound lens having negative refractive power.

The fourth lens L4 is a biconvex lens with positive refractive power, wherein both of an object-side surface S6 and an image-side surface S7 of the fourth lens L4 are spherical surfaces. In the third embodiment, a space is provided between the object-side surface S6 of the fourth lens L4 and the image-side surface S5 of the third lens L3. In other words, the third lens L3 and the fourth lens L4 are not adhered to form a compound lens.

The fifth lens L5 has negative refractive power; an object-side surface S9 of the fifth lens L5 is a convex surface, and an image-side surface S10 of the fifth lens L5 is a concave surface; both of the object-side surface S9 and the image-side surface S10 of the fifth lens L5 are spherical surfaces.

The sixth lens L6 is a biconvex lens with positive refractive power, wherein both of an object-side surface S10 and an image-side surface S11 of the sixth lens L6 are spherical surfaces. In the third embodiment, the object-side surface S10 of the sixth lens L6 and the image-side surface S10 of the fifth lens L5 are correspondingly adhered to form a compound lens having positive refractive power.

The seventh lens L7 has negative refractive power. An object-side surface S12 of the seventh lens L7 is convex at a point where the optical axis Z passes through, and an image-side surface S13 of the seventh lens L7 is concave at a point where the optical axis Z passes through. Both of the object-side surface S12 and the image-side surface S13 of the seventh lens L7 are aspheric surfaces. Additionally, the object-side surface S12 of the seventh lens L7 has an inflection point, so that the object-side surface S12 of the seventh lens L7 gradually changes from convex to concave as the object-side surface S12 extends outward from the point where the optical axis Z passes through. Similarly, the image-side surface S13 of the seventh lens L7 has an inflection point, so that the image-side surface S13 of the seventh lens L7 gradually changes from concave to convex as the image-side surface S13 extends outward from the point where the optical axis Z passes through. In the third embodiment, a space is provided between the object-side surface S12 of the seventh lens L7 and the image-side surface S11 of the sixth lens L6. In other words, the sixth lens L6 and the seventh lens L7 are not adhered to form a compound lens.

Additionally, the optical imaging lens 300 further includes an infrared filter L8 and a protective glass L9, wherein the infrared filter L8 forms an object-side surface S14 facing the object side and an image-side surface S15 facing the image side. The infrared filter L8 is disposed on one side of the image-side surface S13 of the seventh lens L7, thereby restricting infrared rays passing through the optical imaging lens 300 to improve the quality and fidelity of the image. The protective glass L9 forms an object-side surface S16 facing the object side and an image-side surface S17 facing the image side. The protective glass L9 is disposed on one side of the infrared filter L8 and is located between the infrared filter L8 and an image plane Im to protect the infrared filter L8.

In order to keep the optical imaging lens 300 in good optical performance and high imaging quality, the optical imaging lens 300 satisfies:

$$- 0.49 < F / f 1 < - 0.46 ; \qquad ( 1 )$$

$$- 1.27 < F / f 2 < - 1.23 ; \qquad ( 2 )$$

$$0.91 < F / f 3 < 0.94 ; \qquad ( 3 )$$

$$- 0.02 < F / f 23 < - 0.007 ; \qquad ( 4 )$$

$$0.44 < F / f 4 < 0.46 ; \qquad ( 5 )$$

$$- 0.6 < F / f 5 < - 0.4 ; \qquad ( 6 )$$

$$0.84 < F / f 6 < 0.88 ; \qquad ( 7 )$$

$$0.25 < F / f 56 < 0.29 ; \qquad ( 8 )$$

$$- 0.04 < F / f 7 < - 0.02 ; \qquad ( 9 )$$

$$24. < fg 2 < 28. ; \qquad ( 10 )$$

$$0.4 < F / fg 1 < 0.6 ; \qquad ( 11 )$$

$$0.25 < F / fg 2 < 0.27 ; \qquad ( 12 )$$

$$2.4 < F / ( f 1 + f 2 + f 3 + f 4 ) < 3. . \qquad ( 13 )$$

wherein F is a focal length of the optical imaging lens 300; f1 is a focal length of the first lens L1; f2 is a focal length of the second lens L2; f3 is a focal length of the third lens L3; f23 is a focal length (cemented focal length) of the compound lens formed by adhering the second lens L2 and the third lens L3; f4 is a focal length of the fourth lens L4; f5 is a focal length of the fifth lens L5; f6 is a focal length of the sixth lens L6; f56 is a focal length (cemented focal length) of the compound lens formed by adhering the fifth lens L5 and the sixth lens L6; f7 is a focal length of the seventh lens L7; fg1 is a focal length of the first lens assembly G1; fg2 is a focal length of the second lens assembly G2.

Parameters of the optical imaging lens 300 of the third embodiment of the present invention are listed in following Table 5, including the focal length F of the optical imaging lens 300 (also called an effective focal length (EFL)), a F-number (Fno), a maximal field of view (FOV), a radius of curvature (R) of each lens, a distance (D) between each surface and the next surface on the optical axis Z, a refractive index (Nd) of each lens, an Abbe number (Vd) of each lens, the focal length of each lens, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 5
F = 6.84 mm; Fno = 1.73; FOV = 81.0 deg

| | | | | | | Cemented | | |
|---|---|---|---|---|---|---|---|---|
| | | | | | Focal | focal | Focal | |
| Surface | R(mm) | D(mm) | Nd | Vd | length | length | length | Note |
| S1 | 13.253 | 1.236 | 1.583 | 59.382 | −14.038 | | 13.665 | First lens |
| | | | | | | | | L1 |
| S2 | 4.897 | 3.566 | | | | | | |
| S3 | −6.897 | 2.750 | 1.702 | 41.132 | −5.380 | −797.009 | | Second |
| | | | | | | | | lens L2 |
| S4 | 9.823 | 3.021 | 1.720 | 50.332 | 7.254 | | | Third |
| | | | | | | | | lens L3 |
| S5 | −9.803 | 0.625 | | | | | | |
| S6 | 12.133 | 2.269 | 1.744 | 44.893 | 14.949 | | | Fourth |
| | | | | | | | | lens L4 |
| S7 | −130.159 | 0.743 | | | | | | |
| ST | INFINITY | 0.746 | | | | | | Aperture |
| | | | | | | | | ST |
| S9 | 8.218 | 2.401 | 1.923 | 18.896 | −13.669 | 25.850 | 27.062 | Fifth |
| | | | | | | | | lens L5 |
| S10 | 4.293 | 3.266 | 1.497 | 81.556 | 7.850 | | | Sixth |
| | | | | | | | | lens L6 |
| S11 | −32.891 | 3.487 | | | | | | |
| S12 | 24.929 | 1.582 | 1.516 | 64.067 | −241.512 | | | Seventh |
| | | | | | | | | lens L7 |
| S13 | 20.337 | 1.048 | | | | | | |
| S14 | INFINITY | 0.400 | 1.517 | 64.167 | | | | Infrared |
| | | | | | | | | Filter L8 |
| S15 | INFINITY | 1.242 | | | | | | |
| S16 | INFINITY | 0.500 | 1.517 | 64.167 | | | | Protective |
| | | | | | | | | Glass L9 |
| S17 | INFINITY | 0.140 | | | | | | |
| Im | INFINITY | 0.000 | | | | | | Image |
| | | | | | | | | Plane Im |

It could be seen from Table 5 that, in the third embodiment, the focal length F of the optical imaging lens 300 is 6.84 mm, and the Fno is 1.73, and the FOV is 81.0 degrees, wherein the focal length f1 of the first lens L1 is −14.038 mm; the focal length f2 of the second lens L2 is −5.380 mm; the focal length f3 of the third lens L3 is 7.254 mm; the focal length f4 of the fourth lens L4 is 14.949 mm; the focal length f5 of the fifth lens L5 is −13.669 mm; the focal length f6 of the sixth lens L6 is 7.850 mm; the focal length f7 of the seventh lens L7 is −241.512 mm; the focal length f23 (cemented focal length) of the compound lens formed by adhering the second lens L2 and the third lens L3 is −797.009 mm; the focal length f56 (cemented focal length) of the compound lens formed by adhering the fifth lens L5 and the sixth lens L6 is 25.850 mm; the focal length fg1 of the first lens assembly G1 is 13.665 mm; the focal length fg2 of the second lens assembly G2 is 27.062 mm.

Additionally, based on the above detailed parameters, detailed values of the aforementioned conditions (1) to (13) in the third embodiment are as follows:

$$F / f 1 = - 0.488 ; \qquad ( 1 )$$

$$F / f 2 = - 1.272 ; \qquad ( 2 )$$

$$F / f 3 = 0.943 ; \qquad ( 3 )$$

$$F / f 23 = - 0.009 ; \qquad ( 4 )$$

$$F / f 4 = 0.458 ; \qquad ( 5 )$$

$$F / f 5 = - 0.501 ; \qquad ( 6 )$$

$$F / f 6 = 0.872 ; \qquad ( 7 )$$

$$F / f 56 = 0.265 ; \qquad ( 8 )$$

$$F / f 7 = - 0.028 ; \qquad ( 9 )$$

$$fg 2 = 27.062 ; \qquad ( 10 )$$

$$F / fg 1 = 0.501 ; \qquad ( 11 )$$

$$F / fg 2 = 0.253 ; \qquad ( 12 )$$

$$F / ( f 1 + f 2 + f 3 + f 4 ) = 2.458 . \qquad ( 13 )$$

With the parameters from Table 5, in the third embodiment, the focal length of each lens, the focal length (cemented focal length) of each compound lens, the focal length fg1 of the first lens assembly G1, and the focal length fg2 of the second lens assembly G2 satisfy the aforementioned conditions (1) to (13) of the optical imaging lens 300.

Additionally, the optical imaging lens 300 further satisfies:

$$0.514 < f / R 1 < 0.519 ; \qquad ( 14 )$$

$$1.354 < f / R 2 < 1.4 ; \qquad ( 15 )$$

$$- 0.993 < f / R 3 < - 0.961 ; \qquad ( 16 )$$

$$0.673 < f / R 4 < 0.698 ; \qquad ( 17 )$$

$$- 0.699 < f / R 5 < - 0.674 ; \qquad ( 18 )$$

$$0.552 < f / R 6 < 0.565 ; \qquad ( 19 )$$

$$- 0.054 < f / R 7 < - 0.05 ; \qquad ( 20 )$$

$$0.82 < f / R 9 < 0.842 ; \qquad ( 21 )$$

$$1.529 < f / R 10 < 1.595 ; \qquad ( 22 )$$

$$- 0.223 < f / R 11 < - 0.207 ; \qquad ( 23 )$$

$$0.265 < f / R 12 < 0.276 ; \qquad ( 24 )$$

$$0.3 < F / R 13 < 0.4 . \qquad ( 25 )$$

wherein F is the focal length of the optical imaging lens 300; R1 is a radius of curvature of the object-side surface S1 of the first lens L1; R2 is a radius of curvature of the image-side surface S2 of the first lens L1; R3 is a radius of curvature of the object-side surface S3 of the second lens L2; R4 is a radius of curvature of a surface formed by correspondingly adhering the image-side surface S4 of the second lens L2 and the object-side surface S4 of the third lens L3; R5 is a radius of curvature of the image-side surface S5 of the third lens L3; R6 is a radius of curvature of the object-side surface S6 of the fourth lens L4; R7 is a radius of curvature of the image-side surface S7 of the fourth lens L4; R9 is a radius of curvature of the object-side surface S9 of the fifth lens L5; R10 is a radius of curvature of a surface formed by correspondingly adhering the image-side surface S10 of the fifth lens L5 and the object-side surface S10 of the sixth lens L6; R11 is a radius of curvature of the image-side surface S11 of the sixth lens L6; R12 is a radius of curvature of the object-side surface S12 of the seventh lens L7; R13 is a radius of curvature of the image-side surface S13 of the seventh lens L7.

Based on the detailed parameters of Table 5, detailed values of the aforementioned conditions (14) to (25) in the third embodiment are as follows:

$$f / R 1 = 0.516 ; \qquad ( 14 )$$

$$f / R 2 = 1.398 ; \qquad ( 15 )$$

$$f / R 3 = - 0.992 ; \qquad ( 16 )$$

$$f / R 4 = 0.697 ; \qquad ( 17 )$$

$$f / R 5 = - 0.698 ; \qquad ( 18 )$$

$$f / R 6 = 0.564 ; \qquad ( 19 )$$

$$f / R 7 = - 0.053 ; \qquad ( 20 )$$

$$f / R 9 = 0.833 ; \qquad ( 21 )$$

$$f / R 10 = 1.594 ; \qquad ( 22 )$$

$$f / R 11 = - 0.208 ; \qquad ( 23 )$$

$$f / R 12 = 0.275 ; \qquad ( 24 )$$

$$f / R 13 = 0.337 . \qquad ( 25 )$$

With the parameters from Table 5, each of the related values in the third embodiment satisfies the aforementioned conditions (14) to (25) of the optical imaging lens 300.

Moreover, an aspheric surface contour shape Z of each of the object-side surface S1 of the first lens L1, the image-side surface S2 of the first lens L1, the object-side surface S12 of the seventh lens L7, and the image-side surface S13 of the seventh lens L7 according to the third embodiment could be obtained by following formula:

$$Z = \frac{{ch}^{2}}{1 + \sqrt{1 - ( 1 + k ) {c}^{2} {h}^{2}}} + {A}_{2} {h}^{2} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A2, A4, A6, A8, A10, A12, A14 and A16 respectively represents different order coefficient of h.

In the optical imaging lens 300 according to the third embodiment, the conic constant k of each of the aspheric surfaces and the different order coefficient of A2, A4, A6, A8, A10, A12, A14, and A16 are listed in following Table 6:

TABLE 6

| Sur- | | | | |
|---|---|---|---|---|
| face | S1 | S2 | S12 | S13 |
| k | −18.33 | −0.1319 | 28.7669 | 0 |
| A2 | 0 | 0 | 0 | 0 |
| A4 | 1.6560E−03 | 1.1964E−03 | −3.9019E−03 | −3.4008E−03 |
| A6 | −7.8211E−05 | 4.3416E−05 | −1.7468E−05 | 2.0201E−05 |
| A8 | 1.6734E−06 | −1.3711E−05 | −1.3748E−06 | −8.8902E−06 |
| A10 | 3.9644E−09 | 1.3244E−06 | 9.4078E−08 | 1.0378E−06 |
| A12 | −1.0572E−09 | −5.5287E−08 | 7.1939E−09 | −4.7186E−08 |
| A14 | 1.5295E−11 | 1.0005E−09 | 0 | 9.1205E−10 |
| A16 | 0 | 0 | 0 | 0 |

Taking optical simulation data to verify the imaging quality of the optical imaging lens 300, wherein FIG. 3B is a diagram showing the longitudinal chromatic aberration according to the third embodiment. From FIG. 3B, it could be observed that the curves formed by each wavelength are close to one another, thereby significantly enhancing chromatic aberration. The skewness of each curve shows that the deviation of the imaging points of off-axis rays is controlled within the range of ±0.07 millimeters. Therefore, in the third embodiment, chromatic aberration for different wavelengths is significantly improved.

The lateral chromatic aberration according to the third embodiment is illustrated in FIG. 3C. From FIG. 3C, it could be observed that the lateral chromatic aberration of both the shortest wavelength and the longest wavelength irradiating on the image plane is less than 7 micrometers, indicating that the optical imaging lens 300 has low lateral chromatic aberration. The rays of different wavelengths tend to converge at the image plane, thereby improving color accuracy and image quality.

It must be pointed out that the embodiments described above are only some preferred embodiments of the present invention. It is noted that, the parameters listed in Tables are not a limitation of the present invention. All equivalent structures which employ the concepts disclosed in this specification and the appended claims should fall within the scope of the present invention.

What is claimed is:

1. An optical imaging lens, in order from an object side to an image side along an optical axis, comprising:
a first lens assembly consisting of, in order from the object side to the image side along the optical axis, a first lens having negative refractive power, a second lens having negative refractive power, a third lens having positive refractive power, and a fourth lens having positive refractive power, wherein an image-side surface of the second lens and an object-side surface of the third lens are adhered to form a compound lens;
an aperture; and
a second lens assembly consisting of, in order from the object side to the image side along the optical axis, a fifth lens having negative refractive power, a sixth lens having positive refractive power, and a seventh lens having negative refractive power.

2. The optical imaging lens as claimed in claim 1, wherein the compound lens formed by adhering the image-side surface of the second lens and the object-side surface of the third lens has negative refractive power.

3. The optical imaging lens as claimed in claim 1, wherein an image-side surface of the fifth lens and an object-side surface of the sixth lens are correspondingly adhered to form a compound lens having positive refractive power.

4. The optical imaging lens as claimed in claim 2, wherein the second lens is a biconcave lens; the third lens is a biconvex lens.

5. The optical imaging lens as claimed in claim 3, wherein an object-side surface of the fifth lens is a convex surface; the image-side surface of the fifth lens is a concave surface; the sixth lens is a biconvex lens.

6. The optical imaging lens as claimed in claim 1, wherein an object-side surface of the first lens is a convex surface; an image-side surface of the first lens is a concave surface; the fourth lens is a biconvex lens; an object-side surface of the seventh lens is a convex surface, and an image-side surface of the seventh lens is a concave surface.

7. The optical imaging lens as claimed in claim 1, wherein an object-side surface and an image-side surface of the first lens are aspheric surfaces; an object-side surface and an image-side surface of the seventh lens are aspheric surfaces; an object-side surface and the image-side surface of the second lens are spherical surfaces; the object-side surface and an image-side surface of the third lens are spherical surfaces; an object-side surface and an image-side surface of the fourth lens are spherical surfaces; an object-side surface and an image-side surface of the fifth lens are spherical surfaces; an object-side surface and an image-side surface of the sixth lens are spherical surfaces.

8. The optical imaging lens as claimed in claim 1, wherein an object-side surface of the seventh lens is convex at a point where the optical axis passes through; the object-side surface of the seventh lens is an aspheric surface and has at least one inflection point; an image-side surface of the seventh lens is concave at a point where the optical axis passes through; the image-side surface of the seventh lens is an aspheric surface and has at least one inflection point.

9. The optical imaging lens as claimed in claim 1, wherein the optical imaging lens satisfies: 24.00<fg2<28.00, wherein fg2 is a focal length of the second lens assembly.

10. The optical imaging lens as claimed in claim 1, wherein the optical imaging lens satisfies: −0.49<F/f1<−0.46, wherein F is a focal length of the optical imaging lens; f1 is a focal length of the first lens.

11. The optical imaging lens as claimed in claim 1, wherein the optical imaging lens satisfies: −1.27<F/f2<−1.23, wherein F is a focal length of the optical imaging lens; f2 is a focal length of the second lens.

12. The optical imaging lens as claimed in claim 1, wherein the optical imaging lens satisfies: 0.91<F/f3<0.94, wherein F is a focal length of the optical imaging lens; f3 is a focal length of the third lens.

13. The optical imaging lens as claimed in claim 1, wherein the optical imaging lens satisfies: 0.44<F/f4<0.46, wherein F is a focal length of the optical imaging lens; f4 is a focal length of the fourth lens.

14. The optical imaging lens as claimed in claim 1, wherein the optical imaging lens satisfies: −0.60<F/f5<−0.40, wherein F is a focal length of the optical imaging lens; f5 is a focal length of the fifth lens.

15. The optical imaging lens as claimed in claim 1, wherein the optical imaging lens satisfies: 0.84<F/f6<0.88, wherein F is a focal length of the optical imaging lens; f6 is a focal length of the sixth lens.

16. The optical imaging lens as claimed in claim 1, wherein the optical imaging lens satisfies: −0.04<F/f7<−0.02, wherein F is a focal length of the optical imaging lens; f7 is a focal length of the seventh lens.

17. The optical imaging lens as claimed in claim 2, wherein the optical imaging lens satisfies: −0.020<F/f23 <−0.007, wherein F is a focal length of the optical imaging lens; f23 is a focal length of the compound lens formed by adhering the second lens and the third lens.

18. The optical imaging lens as claimed in claim 3, wherein the optical imaging lens satisfies: 0.25<F/f56<0.29, wherein F is a focal length of the optical imaging lens; f56 is a focal length of the compound lens formed by adhering the fifth lens and the sixth lens.

19. The optical imaging lens as claimed in claim 1, wherein the optical imaging lens satisfies: 0.40<F/fg1<0.60, wherein F is a focal length of the optical imaging lens; fg1 is a focal length of the first lens assembly.

20. The optical imaging lens as claimed in claim 1, wherein the optical imaging lens satisfies: 0.25<F/fg2<0.27, wherein F is a focal length of the optical imaging lens; fg2 is a focal length of the second lens assembly.

21. The optical imaging lens as claimed in claim 1, wherein the optical imaging lens satisfies: 2.40<F/(f1+f2+f3+f4)<3.00, wherein F is a focal length of the optical imaging lens; f1 is a focal length of the first lens; f2 is a focal length of the second lens; f3 is a focal length of the third lens; f4 is a focal length of the fourth lens.

22. The optical imaging lens as claimed in claim 1, wherein the optical imaging lens satisfies: 0.30<F/R13<0.40, wherein F is a focal length of the optical imaging lens; R13 is a radius of curvature of an image-side surface of the seventh lens.
